(19) United States
(12) Patent Application Publication
(10) Pub. No.: US 2026/0082247 A1
(43) Pub. Date: Mar. 19, 2026

(54) REDUCTION OF RESOURCE UTILIZATION FOR MINIMIZATION OF DRIVE TESTS IN RADIO ACCESS NETWORKS

(71) Applicant: AT&T Intellectual Property I, L.P., Atlanta, GA (US)

(72) Inventors: Yunpeng Li, Austin, TX (US); Haywood Peitzer, Randolph, NJ (US)

(21) Appl. No.: 18/885,545

(22) Filed: Sep. 13, 2024

(51) Int. Cl. H04W 24/08; H04W 24/10; H04W 64/00

(52) U.S. Cl. CPC H04W 24/08; H04W 24/10; H04W 64/006

(57) ABSTRACT

A processing system of a cellular network may transmit at least a first minimization of drive tests radio access network performance measurement request to a first plurality of endpoint devices in a cellular network, the request having fields including an instruction to collect at least one radio access network performance measurement, an instruction to include a location information associated with a collection of the at least one performance measurement, and an instruction to skip a transmission of a minimization of drive tests radio access network performance measurement report when a recipient endpoint device is not to include the location information. The processing system may then obtain at least a first measurement report from at least a first endpoint device that is capable of including the location information and that is configured to allow an inclusion of the location information, and may store the at least the first measurement report.

The present disclosure relates generally to wireless communication networks, and more particularly to methods, non-transitory computer readable media, and apparatuses for transmitting at least a first minimization of drive tests radio access network performance measurement request to a first plurality of endpoint devices in a cellular network with an instruction to skip transmission of a minimization of drive tests radio access network performance measurement report when the endpoint device is not to include location information. The present disclosure also relates to methods, non-transitory computer readable media, and apparatuses for transmitting at least a first minimization of drive tests radio access network performance measurement request to a first plurality of endpoint devices identified in accordance with a set of non-participating endpoint devices that do not participate in minimization of drive tests radio access network performance measurement reporting. In addition, the present disclosure relates to methods, non-transitory computer readable media, and apparatuses for an endpoint device suppressing a transmission of a minimization of drive tests radio access network performance measurement report in accordance with an instruction to skip the transmission when the endpoint device is to not include location information in the minimization of drive tests radio access network performance measurement report.

### BACKGROUND

Traditionally, cellular network coverage has been optimized through drive tests. Drive tests encompass a technician who drives a vehicle equipped with measurement devices to create a coverage map of the service area by correlating measurements of the received signal strength with the vehicle's location. The received signal strength may, for instance, be the reference signal received power (RSRP) and the measurement equipment may tag the measurements with the vehicle's geographic location by means of a Global Positioning System (GPS) receiver. However, such drive tests are costly and labor intensive. The Third Generation Partnership Project (3GPP) Long Term Evolution (LTE) wireless communications standard specifies a feature called Minimization of Drive Tests (MDT). For example, a user equipment (UE) may perform certain measurements in order to establish and maintain connectivity with the radio access network (RAN), such as RSRP. The MDT feature leverages the existing location based services available at the UE by tagging existing measurements with a location and time stamp, and logging measurements at the UE for later reporting to the network.

### SUMMARY

In one example, the present disclosure discloses a method, non-transitory computer readable medium, and apparatus for transmitting at least a first minimization of drive tests radio access network performance measurement request to a first plurality of endpoint devices in a cellular network with an instruction to skip transmission of a minimization of drive tests radio access network performance measurement report when the endpoint device is not to include location information. For example, a processing system including at least one processor may transmit at least a first minimization of drive tests (MDT) radio access network (RAN) performance measurement request to a first plurality of endpoint devices in a cellular network. The at least the first MDT RAN performance measurement request may include a plurality of fields, the plurality of fields including: at least one instruction to collect at least one MDT RAN performance measurement, an instruction to include a location information associated with a collection of the at least one MDT RAN performance measurement, and an instruction to skip a transmission of a MDT RAN performance measurement report in accordance with the at least the first MDT RAN performance measurement request when a recipient endpoint device is not to include the location information. The processing system may next obtain, via the cellular network, at least a first MDT RAN performance measurement report from at least a first endpoint device of the first plurality of endpoint devices that is capable of including the location information associated with the collection of the at least one MDT RAN performance measurement. The processing system may then store the at least the first minimization of drive tests radio access network performance measurement report that is obtained.

In another example, the present disclosure discloses a method, non-transitory computer readable medium, and apparatus for transmitting at least a first minimization of drive tests radio access network performance measurement request to a first plurality of endpoint devices identified in accordance with a set of non-participating endpoint devices that do not participate in minimization of drive tests radio access network performance measurement reporting. For example, a processing system including at least one processor may identify at least one MDT RAN performance measurement to be collected in an area and identify a first plurality of endpoint devices available in the area to collect the at least one MDT RAN performance measurement. The identifying of the first plurality of endpoint devices may include a reference to a set of non-participating endpoint devices that do not participate in MDT RAN performance measurement reporting. The processing system may next transmit at least a first MDT RAN performance measurement request to the first plurality of endpoint devices. The at least the first MDT RAN performance measurement request may include a plurality of fields, wherein the plurality of fields including: at least one instruction to collect the at least one MDT RAN performance measurement, and an instruction to include a location information associated with a collection of the at least one MDT RAN performance measurement. The processing system may then obtain, via the cellular network, at least a first MDT RAN performance measurement report from at least a first endpoint device of the first plurality of endpoint devices, and may store the at least the first MDT RAN performance measurement report that is obtained.

In still another example, the present disclosure discloses a method, non-transitory computer readable medium, and apparatus for an endpoint device suppressing a transmission of a minimization of drive tests radio access network performance measurement report in accordance with an instruction to skip the transmission when the endpoint device is to not include location information in the minimization of drive tests radio access network performance measurement report. For example, a processing system including at least one processor, e.g., of an endpoint device, may receive a minimization of drive tests radio access network performance measurement request, that includes a plurality of fields, the plurality of fields including: at least one instruction to collect at least one MDT RAN performance measurement, an instruction to include a location information associated with a collection of the at least one MDT RAN performance measurement, and an instruction to skip a transmission of a MDT RAN performance measurement report in accordance with the at least the first MDT RAN performance measurement request when the endpoint device is not to include the location information. The processing system may then determine that the endpoint device is not to include the location information and may suppress a collection or a transmission of the MDT RAN performance measurement report in accordance with the instruction to skip the transmission and in response to determining that the endpoint device is to not include the location information.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example minimization of drive tests radio access network measurement request, in accordance with the present disclosure;

FIG. 3 illustrates an example minimization of drive tests radio access network measurement report, in accordance with the present disclosure;

FIG. 4 illustrates a flowchart of an example method for transmitting at least a first minimization of drive tests radio access network performance measurement request to a first plurality of endpoint devices in a cellular network with an instruction to skip transmission of a minimization of drive tests radio access network performance measurement report when the endpoint device is not to include location information;

FIG. 5 illustrates a flowchart of an example method for transmitting at least a first minimization of drive tests radio access network performance measurement request to a first plurality of endpoint devices identified in accordance with a set of non-participating endpoint devices that do not participate in minimization of drive tests radio access network performance measurement reporting;

FIG. 6 illustrates a flowchart of an example method for an endpoint device suppressing a transmission of a minimization of drive tests radio access network performance measurement report in accordance with an instruction to skip the transmission when the endpoint device is to not include location information in the minimization of drive tests radio access network performance measurement report; and FIG. 7 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, non-transitory computer readable media, and apparatuses for transmitting at least a first minimization of drive tests radio access network performance measurement request to a first plurality of endpoint devices in a cellular network with an instruction to skip transmission of a minimization of drive tests radio access network performance measurement report when the endpoint device is not to include location information, as well as methods, non-transitory computer readable media, and apparatuses for transmitting at least a first minimization of drive tests radio access network performance measurement request to a first plurality of endpoint devices identified in accordance with a set of non-participating endpoint devices that do not participate in minimization of drive tests radio access network performance measurement reporting, and methods, non-transitory computer readable media, and apparatuses for an endpoint device suppressing a transmission of a minimization of drive tests radio access network performance measurement report in accordance with an instruction to skip the transmission when the endpoint device is to not include location information in the minimization of drive tests radio access network performance measurement report.

In particular, examples of the present disclosure utilize cellular endpoint devices, or user equipment (UE (singular) or UEs (plural)), to obtain and report measurements of radio access network performance indicators (e.g., one or more “key performance indicators” (KPIs)), such as signal strength measurements and locations associated with the measurements, to the cellular network. In one example, endpoint devices may comprise UEs equipped to operate according to the specification(s) of one or more wireless cellular communications standards (e.g., 3^{rd} Generation Partnership Project (3GPP) Fourth Generation (4G), Long Term Evolution (LTE), Fifth Generation (5G) (e.g., in some examples including multiple input-multiple output (MIMO) and/or millimeter wave capabilities), and so forth. However, some features may not be universally supported, such as location information determination capabilities, e.g., a Global Positioning System (GPS) and/or Global Navigation Satellite System (GNSS) unit or the like, spatial orientation information determination capabilities (e.g., a gyroscope and compass, or the like), the ability to beam sweep the receive beam, and so forth.

3GPP release 10 introduced a feature called radio measurement collection for Minimization of Drive Tests (MDT). MDT enables cellular operators to utilize endpoint devices in the network to collect radio measurements and associated location info (longitude, latitude, altitude, etc.). Cellular operators can then analyze data collected by MDT to monitor and detect coverage problems (coverage holes, weak coverage areas, pilot pollution, overshoot coverage, etc.) to perform coverage mapping for uplink coverage, cell boundary mapping, etc., and so forth. In most cases, location information is an important component of the data collected. In particular, some measurements are not useful for an intended purpose if location information is absent. Notably, MDT techniques can reduce the number of traditional drive tests, which are costly and time consuming.

MDT is specified for 3G and later technologies and can be used during network deployment, optimization, and troubleshooting. When MDT is enabled, a cellular network may leverage endpoint devices'measurements for radio resource management (RRM) to collect data from endpoint devices in a specific geographic area (e.g., a list of one or more cells). For instance, base stations/cell sites may configure endpoint devices to send measurement reports (periodic or event triggered) with location information (and in some cases other data, such as spatial orientation information or the like). Example measurements may include wireless signal quality (such as reference signal received power (RSRP), reference signal received quality (RSRQ), signal-to-interference-and-noise (SINR) ratio, or the like) of a serving cell and/or intra-frequency, inter-frequency, and/or inter-radio access technology measurements with respect to neighbor cells.

In many cases, such measurements may be meaningless for MDT without associated location information. However, in practice, many endpoint devices may respond to MDT requests, collect measurements, and transmit MDT measurement reports without location information. This can be due to various reasons. For example, some endpoint devices may be configured, e.g., at an operating system level, to omit location information from RRM reporting. This may be due to privacy concerns or other considerations. Likewise, some endpoint devices may lack GPS and/or GNSS capabilities. As a result, large volumes of MDT RAN performance data are collected by endpoint devices and sent to the cellular network without any clear benefit. At the same time, there are also several drawbacks. For example, endpoint device resources are wasted, such as battery life, processing power, memory, etc. In addition, wasteful MDT reporting depletes control channel capacity of the air interface that could otherwise be reallocated. As an additional consequence, throughput of application/user data can be significantly impacted when MDT is enabled. As such, a cellular network may enable MDT sparingly in selected locations. Wasteful MDT measurement collection requests and the consequent wasteful reporting (e.g., without location information) also unnecessarily consumes network capacity and resources of network elements, such as base stations and a trace collection entity (TCE) or TCEs, e.g., in terms of processing power, memory utilization, storage space, heating, power consumption, and so forth. Limited transport network capacity may also be tied up for MDT measurement reports that may ultimately be discarded. In this regard, it should be noted that thousands of endpoint devices may send MDT measurement reports to base stations periodically (e.g., every few seconds). In addition, all of these MDT measurement reports may also be sent from base stations/cell sites (or radio access network (RAN) nodes) to a TCE via the transport network.

Examples of the present disclosure enable a reduction in the number of MDT measurement reports without location information. Consequently, endpoint device and network resources are conserved. In addition, the impacts of MDT on other traffic is reduced. In particular, MDT communications and data volume are reduced, leaving substantial additional bandwidth and other capacity for user data traffic, other network functions, and so forth. To further illustrate, in one example, the present disclosure may include an additional field in a MDT RAN measurement request (e.g., Measurement Configuration for MDT). For instance, the field may have a label of “SkipReportWithoutLocationInfo,” where a value of “1” or “enable” may indicate to a receiving endpoint device that it should not take measurements, nor send a MDT measurement report (or reports) if it cannot include location information for any reason. In one example, an endpoint device may be configured to scan such a field in a received MDT RAN performance measurement request and determine whether the endpoint device is: (1) capable of GPS/GNSS location determination and/or (2) whether the endpoint device is configured to omit accurate location information (e.g., with an accuracy of GPS/GNSS-determined location) from MDT RAN performance measurement reports that may be uploaded back to the cellular network. Depending on the determination, the endpoint device may then either perform MDT RAN performance measurements and send a report to the cellular network, or may decline to send such a report (and to not collect such measurements).

Alternatively, or in addition, in accordance with the present disclosure, a cellular network may maintain a database of endpoint devices, accounts, and/or users that do not support inclusion of location information in MDT RAN performance measurement reports. In particular, the cellular network may exclude endpoint devices in such a list from being sent MDT RAN performance measurement requests. For example, the cellular network may determine that it has received an MDT RAN performance measurement report that excludes location information. The cellular network may then include the sending endpoint device in a list/database of non-participating (e.g., non-location sharing endpoint devices). In one example, an endpoint device may be added to the list after a threshold number of MDT RAN performance measurement reports are received by the cellular network that fail to include location information. For instance, this may prevent the endpoint device from being included in the list prematurely, e.g., merely because the endpoint device may have been in a location or other circumstances in which location measurement was temporarily unavailable, but where the endpoint device is otherwise GPS/GNSS-equipped and is not configured to block location sharing.

In one example, the list/database may also be edited manually. For example, if including location information is disabled by a device maker, then an international mobile equipment identity (IMEI)-type allocation code (TAC) range), or a group of users, such as first responder or governmental users whose locations should not be shared or tracked, e.g., because of sensitivity of their job functions, may be included in the list/database of non-participants. It should be noted that such a list/database may also identify non-participating endpoint devices by phone number, e.g., by international mobile subscriber identity (IMSI), by account number, and so forth. In one example, such a list/database may also be optimized over time via machine learning (ML), such as to predict endpoint devices that may decline to share location information or which may be poor candidates to send MDT RAN performance measurement requests (or alternatively, which are likely participants for location sharing and hence good candidates for sending MDT RAN performance measurement requests).

The first approach addresses those endpoint devices that can acquire GPS/GNSS location, but elect not to include location information in MDT RAN performance measurement reports. Using a designated field/information element in a MDT RAN performance measurement request, an endpoint device can then avoid taking radio measurements and sending a measurement report (or reports) if the endpoint device is configured to not include/send location information. The second approach similarly addresses devices that are not capable or decline to share location information. In addition, the second approach may be implemented without any alteration to 3GPP specifications. The benefit is that it may cover endpoint devices that do not support the new field (or “information element”) of the first approach. In one example, a cellular network may implement a combination of both approaches for optimal result.

In accordance with the present disclosure, the number of MDT RAN performance measurement reports without location information may be greatly reduced. In addition, endpoint device resources are conserved, such as battery capacity and/or energy consumption, processor utilization, memory utilization, and so forth. In addition, network resources, such as processing power, memory, and storage space, network bandwidth/transport network capacity, and the like may also be conserved. Accordingly, MDT communications may cause less network performance degradation. This may allow MDT to be enabled and used more efficiently and effectively. For example, in the past, MDT may have been enabled more sparingly in selected locations because of concern of negative impact to other traffic in the network. However, in accordance with examples of the present disclosure, MDT can be used more often to monitor and optimize the network.

It should be further noted that for MDT RAN performance measurements, a participating endpoint device (e.g., (1) GPS/GNSS equipped and (2) configured for location sharing) may perform synchronization signal (SS) block reference signal received power (RSRP) and/or channel state information (CSI)-RSRP measurements, e.g., as part of beam management (BM) and/or beam recovery (BR) procedures in accordance with a cellular communication protocol employed by the cellular network and implemented at the base station and the endpoint device. In one example, the endpoint device may tag a SS block RSRP and/or CSI-RSRP measurement with a location tag. For instance, the location may be added to a record for the MDT RAN performance indicator measurement. The performance indicator measurements may be layer 1 (L1) or layer 3 (L3) filtered, beam-specific or cell-specific, and different combinations of measurement types may be collected and tagged by the endpoint device with location information (and in one example, spatial orientation information or other information).

In one example, an endpoint device may be configured with a beam recovery procedure upon detection of a beam failure from one or more monitored beams (e.g., if the quality of an associated control channel drops below a threshold and/or upon expiration of a configured timer/counter). For example, a beam recovery procedure may entail the transmission of a beam failure indication from the endpoint device to the cellular network to trigger a transmission beam switch procedure in order to avoid entering a radio link failure (RLF) condition at the endpoint device. In one example, the endpoint device may log the beam failure and corresponding beam recovery attempts at the endpoint device along with location(s) (and in one example spatial orientation information). In other words, in one example, a “performance indicator measurement” may be a notation of a radio link failure condition with respect to a particular directional beam. The record for a beam failure event may also include time stamp(s) associated with the beam failure event. In one example, a record of a beam recovery event may include one or more beam quality measurements/IDs corresponding to the beam(s) monitored by the endpoint device during the beam recovery procedure, along with additional information, such as a modulation coding scheme (MCS) that was being utilized at the time of the event, and so forth.

In yet another example, an endpoint device may experience situations where blockage events occur such that a link quality is impacted before quickly being restored (e.g., due to a vehicle passing between the endpoint device and a base station, etc.) before beam recovery or radio link failure (RLF) procedures are completed, and so forth, such that those procedures are cancelled and the outcome is not reported to the cellular network. However, via MDT RAN performance measurement requests, these radio link interruption (RLI) events (e.g., the occurrence of the events, the locations of these events, etc.) may be recorded at endpoint devices and reported to the cellular network. The cellular network may utilize such information to adjust the configuration of beam management related measurement resources, timer/counters at the endpoint device, or at endpoint devices in general, and so on. An endpoint device that is location-capable and configured for location sharing may log such RLI events and may include a time-stamp, location, and duration of the RLI event along with one or more beam quality measurements/IDs corresponding to the beam(s) monitored by the mobile endpoint device during the beam failure/recovery procedures. As part of the configuration, the mobile endpoint device may be provided with a RLI logging condition defined as a period of time during which a beam failure event has a duration less than a value “X” and is restored within a period of time “T.”

In yet another example, an endpoint device may be configured to record events related to random access channel (RACH) procedures, e.g., along with location and/or spatial orientation information. The RACH event recording may also include a time stamp and other relevant parameters, such as a duration of a RACH failure event, RACH resources selected by the endpoint device (e.g., preamble format, number of repetitions, time/frequency resources, etc.), transmission power, and transmit/receive (Tx/Rx) beamforming utilized at the mobile endpoint device. The recording and reporting via MDT requesting and reporting may provide the cellular network with information regarding RACH failure events that would otherwise not be reported to the cellular network. In addition, the cellular network may determine uplink coverage holes or gaps, adjust related RACH configuration parameters at the endpoint device or base station (e.g., a gNodeB or gNB), and so on.

In one example, a MDT RAN measurement request may request/instruct an endpoint device to detect and measure signals and channels related to initial access procedures (e.g., a primary synchronization signal (PSS), a secondary synchronization signal (SSS), a physical broadcast channel (PBCH), and/or a downlink modulation reference signal (DMRS) contained within a synchronization signaling (SS) block). In addition, in one example, the endpoint device may not perform measurements relating to reception/transmission of control and data channels. Such an arrangement may enable basic coverage determination/optimization at a significantly lower overhead and power consumption than an endpoint device implementing a full radio access protocol (e.g., a 5G NR access protocol). For instance, the endpoint device may collect and tag MDT RAN performance measurements without utilizing uplink transmission capabilities, except to report the records to the cellular network periodically or on demand. In this case, a performance indicator measurement configuration of the endpoint device may be preconfigured/preloaded, or provided by dedicated signaling via another radio access technology (e.g., LTE). In another example, the endpoint device may measure a reference signal (RS), or multiple reference signals, in addition to the SS-block, such as a channel station information reference signal CSI-RS, via a predetermined or preloaded configuration of the endpoint device, e.g., which may be activated via a MDT RAN performance measurement request transmitted to the endpoint device.

In one example, an endpoint device may store records of performance indicator measurements in a local memory until polled by the cellular network for transmission. In one example, the endpoint device may be configured with a burst duration and a period. For instance, the burst duration may define the duration during which the endpoint device shall collect consecutive performance indicator measurements and tag the measurements with location(s) and spatial orientation information, whereas the period defines the beginning of each burst. For instance, the endpoint device may be configured to collect/tag performance indicator measurements for K1 milliseconds every K2 seconds. In another example, the endpoint device may be configured to collect and tag performance indicator measurements only after a condition has been met (e.g., the measurement falls above or below a predefined threshold or a relative threshold, such as a 20 percent drop in received signal strength as compared to an average received signal strength in a preceding time period).

Alternatively, or in addition, an endpoint device may indicate to the cellular network that it has records of MDT RAN performance indicator measurements ready for transmission. For example, the endpoint device may allocate a limited amount of memory and/or storage for the records of MDT RAN performance measurements. Accordingly, in one example the endpoint device may indicate to the cellular network to poll the records of MDT RAN performance measurements before the allocated memory and/or storage capacity is reached or exhausted. In another example, the endpoint device may collect MDT RAN performance measurements while not connected to the network (e.g., in a radio resource control (RRC) idle (RRC_IDLE) mode). For instance, the MDT RAN performance request may instruct the endpoint device to collect and tag performance indicator measurements while the endpoint device is not connected to the cellular network. For example, the cellular network may configure the endpoint device to begin the collection of measurements and the tagging of measurements with locations when the endpoint device transitions from a RRC connected (RRC_CONNECTED) mode to an RRC_IDLE mode. Upon reconnection to the cellular network (e.g., an RRC_CONNECTED mode), the endpoint device may signal to the cellular network the availability of records of MDT RAN performance measurements. In one example, an endpoint device may initiate a random access procedure to indicate to the cellular network the availability of records of RAN performance measurements. In another example, the endpoint device may transmit a scheduling request. For instance, the endpoint device may indicate in “message 3” of a random access procedure that the “cause” is “mobile originated data.” Alternatively, the endpoint device may indicate directly that the cause is the availability of the records/reports of MDT RAN performance measurements. In one example, the cellular network may indicate to the mobile endpoint device to report only a subset of the MDT RAN performance measurements (e.g., for measurements taken during an indicated time period or over a given duration, for measurements taken on one or more specific carriers, for measurements of one or more specified measurement types and/or performance indicators, and so forth).

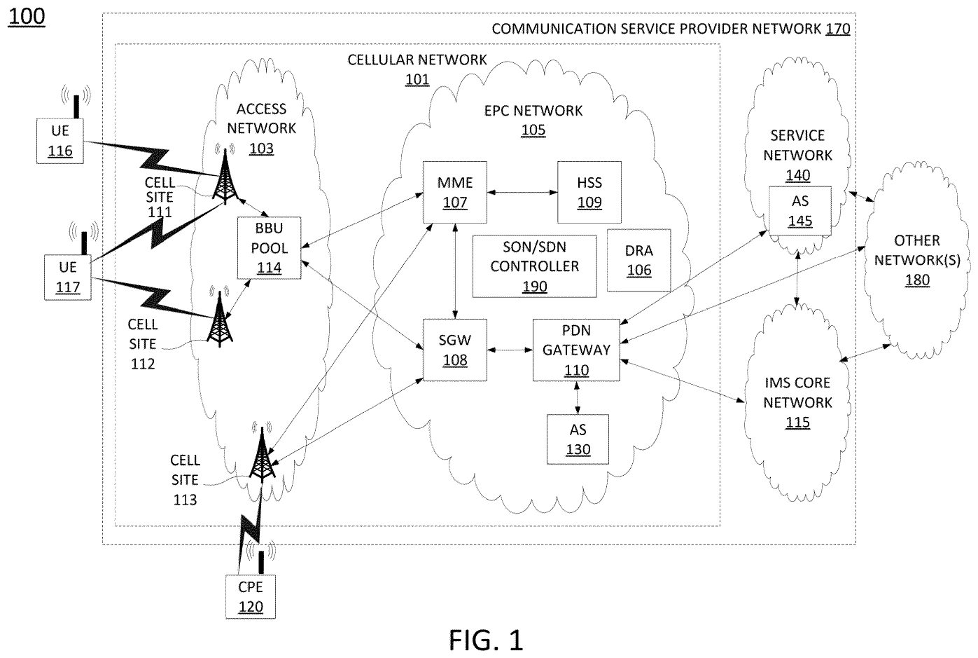

Examples of the present disclosure thus allow the cellular network to identify the radio conditions encountered by endpoint devices, such as during beam failure and radio link interruption events, optimize the transmit beams at a given base station antenna, deploy new antennas that take into account the blocking of signals, adapt the locations of existing antennas, change how multiple antennas coordinate including no coordination, change the boresight of existing antenna arrays without changing the transmitters locations, minimize drive tests, reduce operating expenses and overhead associated with the collection of such measurements, and/or allow the expansion of more comprehensive drive tests with the same or reduced network load, and so forth. These and other aspects of the present disclosure are discussed in greater detail below in connection with the examples of FIGS. 1-7.

To better understand the present disclosure, FIG. 1 illustrates an example network, or system 100 in which examples of the present disclosure may operate. In one example, the system 100 includes a communication service provider network 170. The communication service provider network 170 may comprise a cellular network 101 (e.g., a 4G/Long Term Evolution (LTE) network, a 4G/5G hybrid network, or the like), a service network 140, and a core network, e.g., an IP Multimedia Subsystem (IMS) core network 115. The system 100 may further include other networks 180 connected to the communication service provider network 170. FIG. 1 also illustrates various mobile endpoint devices, e.g., user equipment (UE) 116 and 117. The UE 116 and 117 may each comprise a cellular telephone, a smartphone, a tablet computing device, a laptop computer, a pair of computing glasses, a wireless enabled wristwatch, or any other cellular-capable mobile telephony and computing devices (broadly, “a mobile endpoint device”).

In one example, the cellular network 101 comprises an access network 103 and a core network, Evolved Packet Core (EPC) network 105. In one example, the access network 103 comprises a cloud RAN. For instance, a cloud RAN is part of the 3^{rd} Generation Partnership Project (3GPP) 5G specifications for mobile networks. As part of the migration of cellular networks towards 5G, a cloud RAN may be coupled to an EPC network until new cellular core networks are deployed in accordance with 5G specifications. In one example, access network 103 may include cell sites 111 and 112 and a baseband unit (BBU) pool 114. In a cloud RAN, radio frequency (RF) components, referred to as remote radio heads (RRHs), may be deployed remotely from baseband units, e.g., atop cell site masts, buildings, and so forth. In one example, the BBU pool 114 may be located at distances as far as 20-80 kilometers or more away from the antennas/remote radio heads of cell sites 111 and 112 that are serviced by the BBU pool 114. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site, may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 113 may include RRH and BBU components. Thus, cell site 113 may comprise a self-contained “base station.” With regard to cell sites 111 and 112, the “base stations” may comprise RRHs at cell sites 111 and 112 coupled with respective baseband units of BBU pool 114.

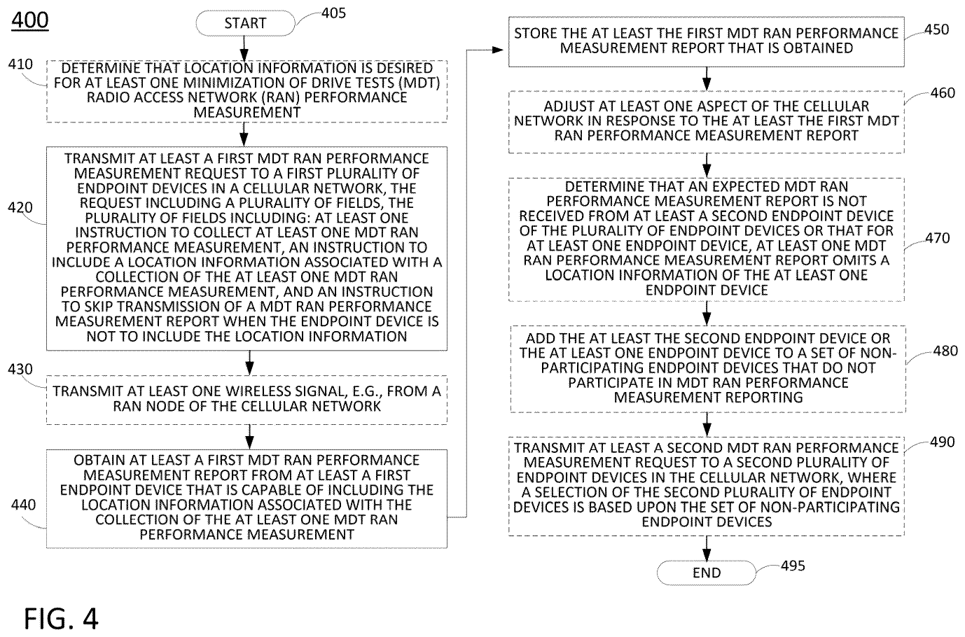

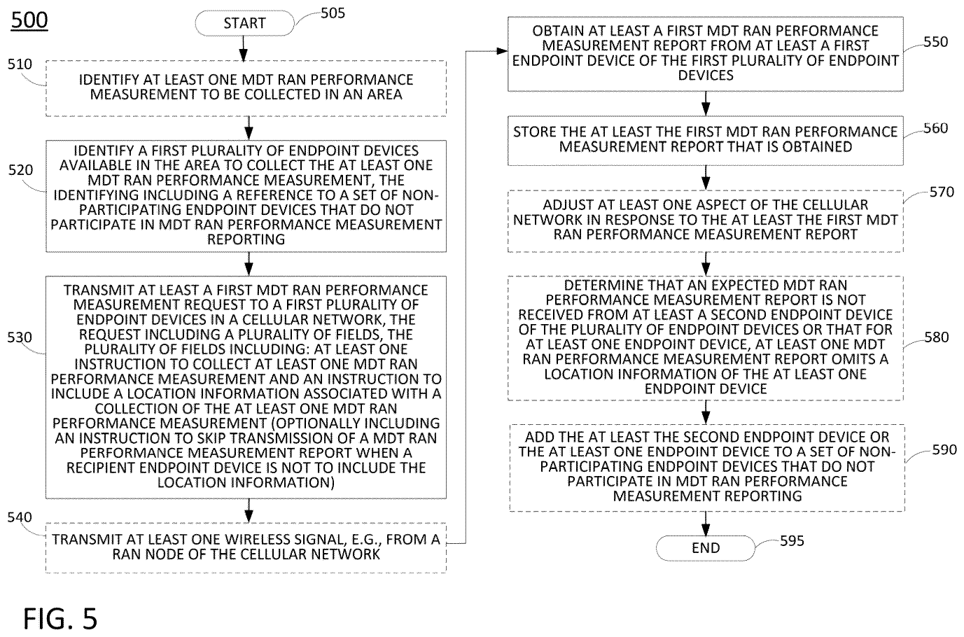

In accordance with the present disclosure, any one or more of cell sites 111-113 may be deployed with antenna and radio infrastructures, including multiple input multiple output (MIMO) and millimeter wave antennas. Furthermore, in accordance with the present disclosure, a base station (e.g., cell sites 111-113 and/or baseband units within BBU pool 114) may comprise all or a portion of a computing device or system, such as computing system 700, and/or processing system 702 as described in connection with FIG. 7 below, and may be configured to provide one or more functions in connection with the example methods of FIGS. 4 and 5, and for performing various other operations in accordance with the present disclosure.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 7 and discussed below) or multiple computing devices collectively configured to perform various steps, functions, and/or operations in accordance with the present disclosure.

As further illustrated in FIG. 1, CPE 120 may comprise a user equipment, e.g., an endpoint device comprising a cellular telephone, a smartphone, a tablet computing device, a laptop computer, or any other cellular-capable mobile telephony and computing devices. In one example, CPE 120 may comprise a wireless transceiver for a fixed wireless broadband (FWB) deployment with one or more directional antennas (e.g., having a half-power azimuthal beamwidth of 120 degrees or less, 90 degrees or less, 60 degrees or less, etc.).

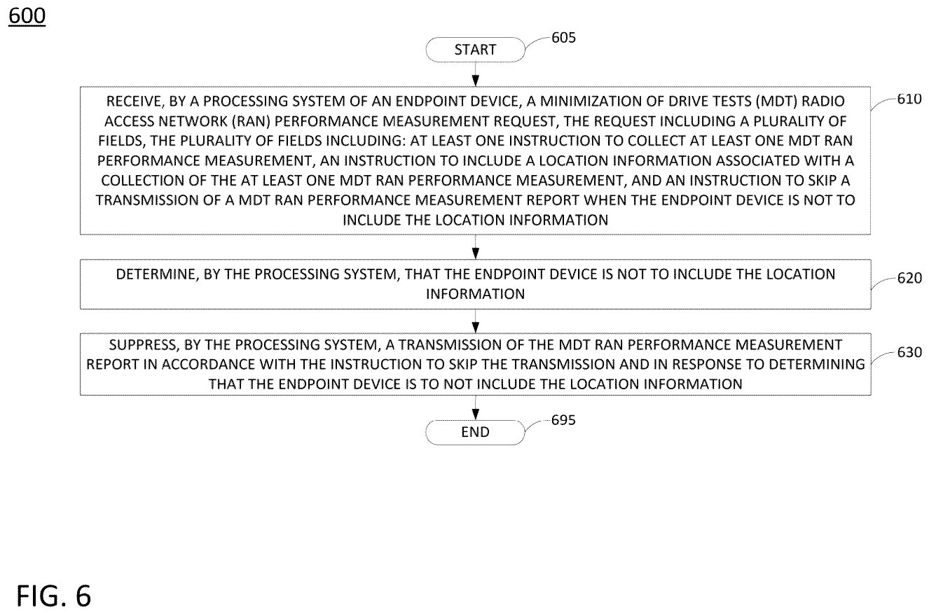

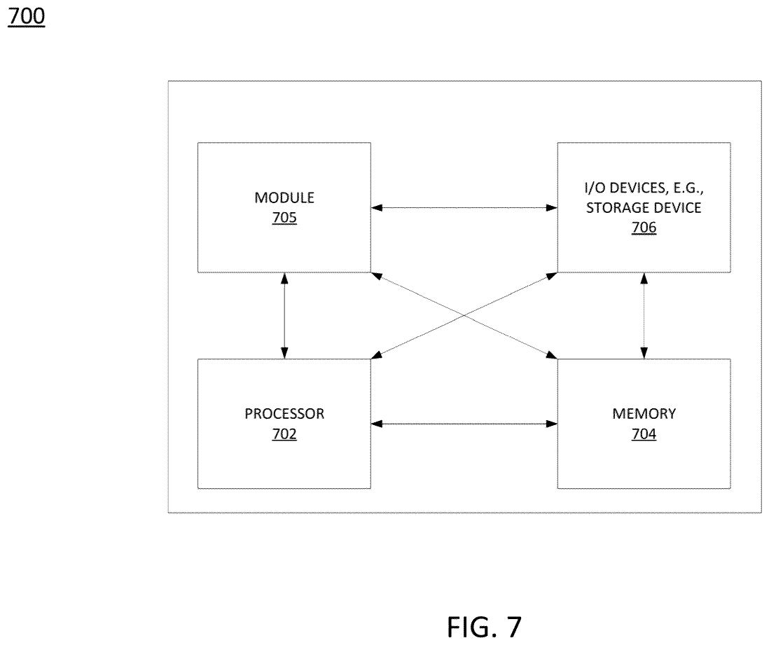

In one example, each of the UE 116 and 117, and the CPE 120 may comprise all or a portion of a computing device or system, such as computing system 700, and/or processing system 702 as described in connection with FIG. 7 below, and may be configured to provide one or more functions such as those described below in connection with the example method 600 of FIG. 6, and for performing various other operations in accordance with the present disclosure. In one example, each of UE 116, UE 117, and CPE 120 may include a GPS/GNSS unit for determining a location. However, for illustrative purposes, in one example, at least one of the UE 116, UE 117, and CPE 120 may specifically lack such a GPS/GNSS unit for location determination capability. In one example, UE 116, UE 117, and/or CPE 120 may also include a MIMO antenna to receive multi-path and/or spatial diversity signals, a gyroscope and compass to determine orientation(s), and so forth.

In one example, the EPC network 105 provides various functions that support wireless services in an LTE and beyond environment. In one example, EPC network 105 is an Internet Protocol (IP) packet core network that supports both real-time and non-real-time service delivery across a LTE network, e.g., as specified by the 3GPP standards. In one example, cell sites 111 and 112 in the access network 103 are in communication with the EPC network 105 via baseband units in BBU pool 114. In operation, UE 116 may access wireless services via the cell site 111 and UE 117 may access wireless services via the cell site 112 located in the access network 103. It should be noted that any number of cell sites can be deployed in access network. In one illustrative example, the access network 103 may comprise one or more cell sites.

In EPC network 105, network devices such as Mobility Management Entity (MME) 107 and Serving Gateway (SGW) 108 support various functions as part of the cellular network 101. For example, MME 107 is the control node for the LTE access network. In one embodiment, MME 107 is responsible for UE (User Equipment) tracking and paging (e.g., such as retransmissions), bearer activation and deactivation process, selection of the SGW, and authentication of a user. In one embodiment, SGW 108 routes and forwards user data packets, while also acting as the mobility anchor for the user plane during inter-cell handovers and as the anchor for mobility between 5G, LTE and other wireless technologies, such as 2G and 3G wireless networks.

In addition, EPC network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise a packet data network (PDN) gateway 110 which serves as a gateway that provides access between the EPC network 105 and various data networks, e.g., service network 140, IMS core network 115, other network(s) 180, and the like. The packet data network gateway 110 is also referred to as a PDN gateway, a PDN GW or a PGW. In addition, the EPC network 105 may include a Diameter routing agent (DRA) 106, which may be engaged in the proper routing of messages between other elements within EPC network 105, and with other components of the system 100, such as a call session control function (CSCF) (not shown) in IMS core network 115. For clarity, the connections between DRA 106 and other components of EPC network 105 are omitted from the illustration of FIG. 1.

In one example, service network 140 may comprise one or more devices, such as application server (AS) 145 for providing services to subscribers, customers, and or users. For example, communication service provider network 170 may provide a cloud storage service, web server hosting, and other services. As such, service network 140 may represent aspects of communication service provider network 170 where infrastructure for supporting such services may be deployed. In one example, AS 145 may comprise all or a portion of a computing device or system, such as computing system 700, and/or processing system 702 as described in connection with FIG. 7 below, specifically configured to provide one or more service functions in accordance with the present disclosure, such as a network-based secure data storage for MDT RAN performance measurement records. For instance, cell sites 111-113 may collect MDT performance measurements/measurement records along with associated locations (and in some examples, other information, such as time stamp information, spatial orientation information, etc., broadly “performance indicator measurement records”) from UE 116, UE 117, and/or CPE 120, and may forward the performance indicator measurement records to AS 145 for storage. In one example, AS 145 may comprise a trace collection entity (TCE). Although a single application server, AS 145, is illustrated in service network 140, it should be understood that service network 140 may include any number of components to support one or more services that may be provided to one or more subscribers, customers, or users by the communication service provider network 170.

In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general.

In accordance with the present disclosure, any one or more of the components of EPC network 105 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 107 may comprise a vMME, SGW 108 may comprise a vSGW, and so forth. In this regard, the EPC network 105 may be expanded (or contracted) to include more or less components than the state of EPC network 105 that is illustrated in FIG. 1. In this regard, the EPC network 105 may also include a self-optimizing network (SON)/software defined network (SDN) controller 190.

In one example, SON/SDN controller 190 may function as a self-optimizing network (SON) orchestrator that is responsible for activating and deactivating, allocating and deallocating, and otherwise managing a variety of network components. For instance, SON/SDN controller 190 may activate and deactivate antennas/remote radio heads of cell sites 111 and 112, respectively, may allocate and deactivate baseband units in BBU pool 114, and may perform other operations for activating antennas based upon a location and a movement of a mobile endpoint device or a group of mobile endpoint devices, in accordance with the present disclosure.

In one example, SON/SDN controller 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

In one example, SON/SDN controller 190 may comprise all or a portion of a computing device or system, such as computing system 700, and/or processing system 702 as described in connection with FIG. 7 below, and may be configured to perform various operations in accordance with the present disclosure. For example, SON/SDN controller 190 may ensure that a cell site 111-113 and/or baseband unit of BBU pool 114 is provisioned with configuration code which, when executed by a processing system of the respective component(s), cause various operations in connection with the examples of FIGS. 4-5 to be performed. For instance, SON/SDN controller 190 may store such configuration code and provision the code to the respective component(s), or may direct the respective component(s) to obtain the configuration code from another repository.

In accordance with the present disclosure, SON/SDN controller 190 may therefore control various components within EPC network 105 and/or within access network 103 to support the traffic that is accommodated by the activation of antennas/remote radio heads of cell sites 111 and 112, respectively and the allocation of baseband units in BBU pool 114. For instance, SON/SDN controller 190 (e.g., performing functions of a SON orchestrator) may activate an antenna of cell site 111 and assign a baseband unit in BBU pool 114 when a group of a mobile endpoint device is detected near the cell site 111. SON/SDN controller 190 (e.g., performing functions of a SDN controller) may further instantiate VNFs to function as routers, switches, gateways, and the like to ensure that sufficient backhaul resources are available for the traffic to transit the access network 103 and/or EPC network 105. In addition, as mentioned above, any one or more of the DRA 106, MME 107, SGW 108, HSS 109, and PGW 110 may comprise VNFs instantiated on host devices. As such, SON/SDN controller 190 may perform similar operations to instantiate, configure, reconfigure, and decommission such components in support of examples of the present disclosure.

Accordingly, the SON/SDN controller 190 may be connected directly or indirectly to any one or more network elements of EPC network 105, and of the system 100 in general. Due to the relatively large number of connections available between SON/SDN controller 190 and other network elements, none of the actual links to the application server are shown in FIG. 1. Similarly, intermediate devices and links between DRA 106, MME 107, SGW 108, cell sites 111 and 112, PDN gateway 110, and other components of system 100 are also omitted for clarity, such as additional routers, switches, gateways, and the like.

As further illustrated in FIG. 1, EPC network 105 may include an application server (AS) 130, which may comprise all or a portion of a computing device or system, such as computing system 700, and/or processing system 702 as described in connection with FIG. 7 below, and may be configured to provide one or more functions in connection with the example methods of FIGS. 4 and 5, and for performing various other operations in accordance with the present disclosure. For example, AS 130 may instruct cell sites 111-113 and/or BBU pool 114 to initiate MDT RAN performance measurements. For example, AS 130 may specify the types of RAN performance measurements to be collected, the time periods over which the RAN performance measurements are to be collected and/or the number of RAN performance measurements (or number of records) desired, and so forth. In one example, AS 130 may also indicate whether location information is being requested (e.g., detailed location information from an endpoint device's GPS/GNSS unit). Accordingly, cell sites 111-113 and/or BBU pool 114 may transmit an MDT RAN performance measurement request to one or more available endpoint devices. To illustrate, cell site 111 may send MDT RAN performance measurement requests to UEs 116 and 117. In one example, the MDT RAN performance measurement requests may be transmitted to the respective UEs via a control channel, e.g., a physical downlink control channel (PDCCH), or the like.

In one example, the MDT RAN performance measurement requests may specify to UE 116 and/or UE 117 to collect RAN performance measurements of a particular type of performance indicator, to collect measurements with a particular periodicity, to report measurements with a particular periodicity, to report measurement records on demand, to report measurement records via a particular type of radio access technology (e.g., via LTE components of cellular network 101), to report measurement records when a measurement of a performance indicator exceeds a fixed or relative threshold, and so on. To illustrate, example MDT RAN performance measurements specified in an MDT RAN performance measurement request may include a received signal strength, e.g., a reference signal received power (RSRP), a bit error rate, a packet loss rate, a round trip time, a delay measure, a beam failure event, a radio link interruption event, a random access procedure failure event, and so forth.

To illustrate, UE 116, UE 117, and/or CPE 120 may receive at least one wireless signal from one of the cell sites 111-113, capture a measurement of a RAN performance indicator based upon the at least one wireless signal, record a location for the MDT RAN performance measurement (and in some cases spatial orientation information), transmit to the cellular network 101 the measurement, the location (and in some cases, spatial orientation information), and so on. The at least one RAN performance measurement may comprise a received signal strength, a bit error rate, a packet loss rate, a round trip time, a delay measure, a beam failure event, a radio link interruption event, a random access procedure failure event, or the like. The transmitting may be to the same one of the cell sites 111-113 that transmits the at least one wireless signal, or may be to a different one of the cell sites 111-113. For example, the UE 116, UE 117, and/or CPE 120 may collect a MDT RAN performance measurement in an RRC_IDLE mode, and may transmit a MDT RAN performance measurement report at a later time when the UE 116, UE 117, and/or CPE 120 reconnects to the cellular network 101, e.g., in an RRC_CONNECTED mode, which may involve a different cell site as the UE 116, UE 117, and/or CPE 120 moves throughout the environment.

In addition, in accordance with the present disclosure, an MDT RAN performance measurement request may further include an indicator to the receiving endpoint device to skip MDT RAN performance measurement reporting without location information. For instance, the receiving endpoint device may be configured to determine whether the endpoint device is capable of detailed location determination (e.g., whether the endpoint device is GPS/GNSS equipped). If not, the endpoint device may then skip MDT RAN performance measurement collection and/or reporting. Alternatively, or in addition, the endpoint device may determine whether the endpoint device will not be able to include location information, e.g., even if the endpoint device is GPS/GNSS enabled. For example, the endpoint device may determine that it is configured to not share location information (and thus would not include detailed location information in an MDT RAN performance measurement report). Alternatively, or in addition, the endpoint device may determine that GPS/GNSS is temporarily not available, e.g., due to a location within a canyon, due to an inability to track positioning reference satellites, and so forth. In such cases, the endpoint device may therefore decline to collect MDT RAN performance measurements and/or may suppress (e.g., specifically determine not to send) one or more reports with such MDT RAN performance measurements back to the communication service provider network 170.

It should also be noted that in some cases, endpoint devices, such as UE 116, UE 117, and/or CPE 120, may be configured for control plane (e.g., C-plane) MDT in which the desired MDT RAN performance measurements, reporting intervals, etc. are indicated in an MDT measurement request from a cell site/base station. However, in another example, one or more endpoint devices may also be configured for user plane (U-plane) MDT, e.g., in which a network operator application may be loaded on an endpoint device and where one or more configurations for MDT RAN performance measurements may be pre-loaded onto the endpoint device or may be loaded over-the-air (OTA), e.g., via application layer communication with AS 130, AS 145, or the like.

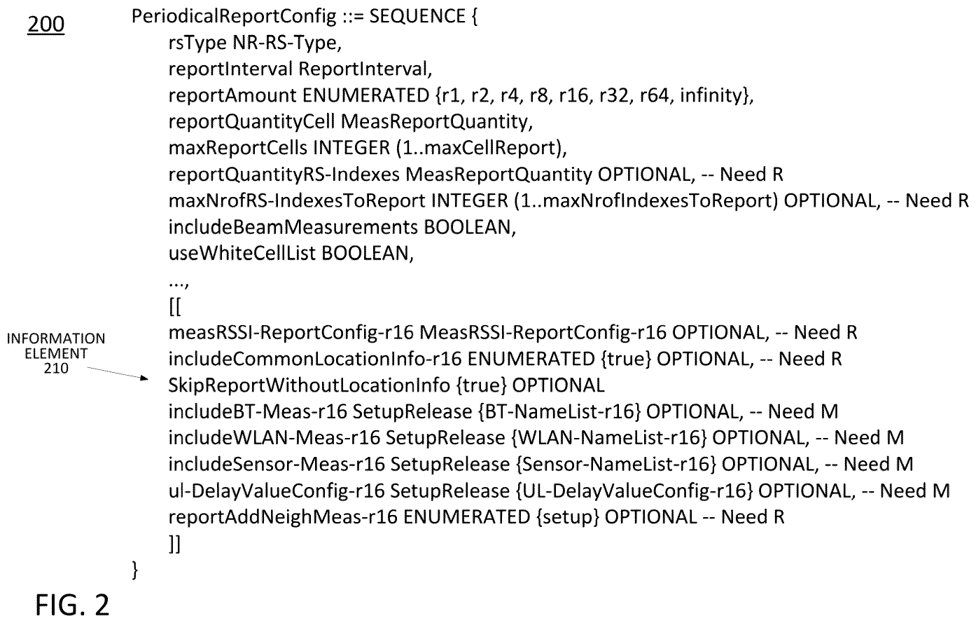

In accordance with the present disclosure, an example MDT RAN performance measurement request 200 is illustrated in FIG. 2. In particular, the MDT RAN performance measurement request 200 may include an information element 210, or field(s), that indicates to a receiving endpoint device to skip MDT RAN performance measurement collection and/or reporting if the endpoint device is not able to include detailed location information (e.g., determined via GPS/GNNS) for any reason. Referring again to the example of FIG. 1, UEs 116 and 117 may receive similar MDT RAN performance measurement requests, e.g., via cell site 111, such as MDT performance measurement request 200. However, for illustrative purposes, UE 116 may lack GPS/GNSS capability or may be configured, e.g., at an operating system level, to block sharing of detailed location information. Accordingly, in one example, UE 116 may decline to collect and report MDT RAN performance measurements. On the other hand, UE 117 may be GPS/GNSS equipped and may therefore collect and report MDT RAN performance measurements. As such, cell site 111 may receive one or more MDT RAN performance measurement reports only from UE 117.

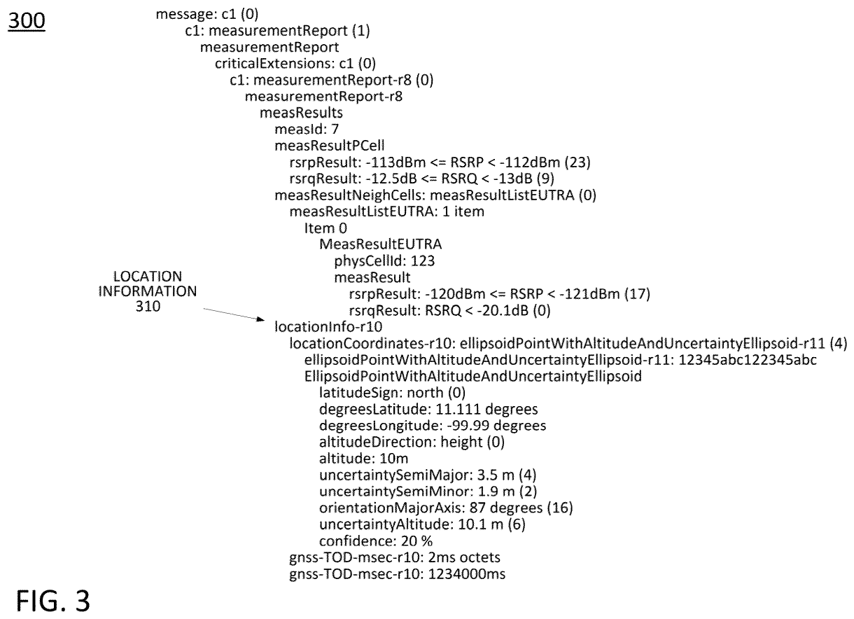

An example MDT RAN performance measurement report 300 is illustrated in FIG. 3. In particular, the example MDT RAN performance measurement report 300 may include location information 310. In accordance with the present disclosure, certain MDT RAN performance measurements are valuable when detail location information is included, e.g., having an accuracy that can be obtained via GPS/GNSS unit. In this case, the example MDT RAN performance measurement report 300 indicates latitude and longitude with a zone of uncertainty defined by an ellipsoid having an orientation, a major axis, and a minor axis. In this example, the maximum uncertainty is 3.5 meters along the major axis of the ellipsoid of uncertainty. For illustrative purposes, this accuracy may be of sufficient utility for MDT RAN performance measurements. However, a different MDT RAN performance measurement report might omit latitude and longitude altogether, or may provide an estimated latitude and longitude (e.g., based upon triangulation, etc.) with a larger uncertainty, such as 10 meters or greater. In these cases, the MDT RAN performance measurement reports may be of little value unless the particular MDT investigation is of the more rare variety in which precise location is not germane.

In one example, cell site 111 may forward to AS 130 (and/or to AS 145) MDT RAN performance measurement reports received from various endpoint devices. In one example, communication service provider network 170 may determine, e.g., via AS 130 and/or AS 145, that an expected MDT RAN performance measurement report is not received from one or more endpoint devices, such as UE 116. For example, UE 116 may determine that it is not GPS/GNSS enabled, or may determine that it is configured to block/not share location information. In either case, UE 116 may then elect not to send one or more MDT RAN performance measurement reports in response to the field/information element contained in the MDT RAN performance measurement request indicating to skip MDT RAN performance measurement reports without location information. In one example, communication service provider network 170 may determine that one or more expected MDT RAN performance measurement reports are not received from UE 116. In response, communication service provider network 170 may add UE 116 to a list of non-participating (e.g., non-location sharing) endpoint devices. Alternatively, or in addition, communication service provider network 170 may determine that one or more MDT RAN performance measurement reports from UE 116 are received, but omit location information, or do not include detailed location information (e.g., determined from a GPS/GNSS unit, as opposed to a location estimate based upon the serving base station or the like). In such case, communication service provider network 170 may similarly add UE 116 to a list of non-participating (e.g., non-location sharing) endpoint devices.

In one example, to avoid prematurely adding an endpoint device to such a list, communication service provider network 170 may add an endpoint device when a threshold number of expected MDT RAN performance measurement reports are not received and/or when a threshold number of MDT RAN performance measurement reports are received without GPS/GNSS location information. In one example, the count and the threshold may be with respect to multiple MDT RAN performance measurement requests from different cell sites in different locations and at different times. For instance, this may avoid adding UE 116 to such a list when UE 116 is merely temporarily unable to provide location information (but is otherwise capable of and not blocked from location determination and sharing).

In one example, AS 130 (and/or AS 145) may maintain and may refer to such a list when initiating MDT RAN performance measurement collections via one or more cell sites. For instance, AS 130 may instruct the cell site(s) to omit sending MDT RAN performance measurement requests to any endpoint devices on such a list. For instance, AS 130 may initiate MDT RAN performance measurement collection in an area including cell sites 111-113. However, CPE 120 may be on a list of non-participating endpoint devices. As such, cell site 113 may omit sending an MDT RAN performance measurement request to CPE 120. For instance, CPE 120 may be a fixed wireless broadband (FWB) device designed to remain relatively stationary. As such, CPE 120 may be manufactured without a GPS/GNSS unit. In addition, this may cause CPE 120 to be included in a list of non-participating endpoint devices. For instance, CPE 120 may be added to such a list in response to the cellular network 101 obtaining an IMEI/TAC range from a device manufacturer indicating that CPE 120 is not GPS/GNSS equipped. Alternatively, or in addition, this may be learned by the communication service provider network 170 over time, e.g., after a threshold number of MDT RAN performance measurement requests have been sent to CPE 120 without corresponding responses and/or with responses omitting GPS/GNSS location information. By reducing wasteful MDT data traffic and the number of MDT RAN performance measurement reports that would otherwise be discarded, the communication service provider network 170 may have a higher quality data set of MDT RAN performance measurements from participating endpoint devices for one or more locations. In addition, the communication service provider network 170 may enable longer or more involved MDT RAN performance measurement collections, thereby providing a more accurate, or more representative data set.

In one example, AS 130 may utilize one or more of the MDT RAN performance measurement reports, and the RAN performance indicator measurements contained therein, to adjust at least one aspect of the cellular network 101 in response. For instance, in one example, AS 130 may collect, aggregate, and store the MDT RAN performance measurement reports via cell sites 111-113. In another example, the MDT RAN performance measurement reports/records may be stored in a separate data storage system, e.g., at AS 145, or the like. In such an example, AS 130 may retrieve one or more records from AS 145. In one example, the adjusting the at least one aspect of the cellular network 101 may comprise activating a remote radio head, activating a base band unit, deactivating a remote radio head, deactivating a baseband unit, changing a transmit power of a base station, changing a boresight direction of an antenna array (including adjusting tilt and azimuth bearing), changing a beamwidth of a gain pattern of an antenna array, changing a channel coding scheme availability at a base station, changing a base station backhaul configuration, and so forth. In one example, AS 130 may configure components of the cellular network 101 directly. For instance, AS 130 may maintain communications with BBU pool 114, cell sites 111-113, CPE 120, and so forth, via PDN gateway 110 and SGW 108, for example. In another example, AS 130 may send a command or request to SON/SDN controller 190 for the SON/SDN controller 190 to configure the relevant component(s) of the cellular network 101.

In still another example, SON/SDN controller 190 may retrieve and process MDT RAN performance measurement reports/records, e.g., from AS 145, where the records may be stored after collection via cell sites 111-113. In particular, SON/SDN controller 190 may adjust aspects of cellular network 101 in response to the MDT RAN performance measurements by UE 116, UE 117, and/or CPE 120, such as: activating a remote radio head, activating a baseband unit, deactivating a remote radio head, deactivating a baseband unit, changing a transmit power of a base station, changing a boresight direction of an antenna array (including adjusting tilt and azimuth bearing), changing a beamwidth of a gain pattern of an antenna array, changing a channel coding scheme availability at a base station, changing a base station backhaul configuration, and so forth. In this regard, it should be noted that some of the functions described herein with respect to SON/SDN controller 190 may instead be performed by AS 130, and vice versa.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For instance, in one example, SON/SDN controller 190 may be spilt into separate components to operate as a SON orchestrator and a SDN controller, respectively. Similarly, although the SON/SDN controller 190 is illustrated as a component of EPC network 105, in another example SON/SDN controller 190, and/or other network components may be deployed in an IMS core network 115 instead of being deployed within the EPC network 105, or in other portions of system 100 that are not shown, while providing essentially the same functionality. Similarly, functions described herein with respect to AS 130 may alternatively or additional be provided by AS 145, by SON/SDN controller 190, or other components, and vice versa.

In addition, although aspects of the present disclosure have been discussed above in the context of a long term evolution (LTE)-based wireless network, examples of the present disclosure are not so limited. Thus, the teachings of the present disclosure can be applied to other types of wireless networks (e.g., a 2G network, a 3G network, a 5G network, an integrated network, e.g., including any two or more of 2G-5G infrastructure and technologies, and the like), that are suitable for use in connection with examples of the present disclosure for channel sounding via an in-service base station. For example, as illustrated in FIG. 1, the cellular network 101 may represent a “non-stand alone” (NSA) mode architecture where 5G radio access network components, such as a “new radio” (NR), “gNodeB” (or “gNB”), and so forth are supported by a 4G/LTE core network (e.g., a Evolved Packet Core (EPC) network 105). However, in another example, system 100 may instead comprise a 5G “standalone” (SA) mode point-to-point or service-based architecture where components and functions of EPC network 105 are replaced by a 5G core network, which may include an access and mobility management function (AMF), a user plane function (UPF), a session management function (SMF), a policy control function (PCF), a unified data management function (UDM), an authentication server function (AUSF), an application function (AF), a network repository function (NRF), and so on. For instance, in such a network, application server (AS) 130 of FIG. 1 may represent an application function (AF) for adjusting aspects of a cellular network in response to MDT RAN performance indicator reports/records and/or the measurements thereof, and for performing various other operations in accordance with the present disclosure. In one example AS 130 may comprise one or more of: a network data analytics function (NWDAF), a service management orchestrator (SMO) and/or a radio access network (RAN) intelligent controller (RIC), and so forth. Alternatively, or in addition, SON/SDN controller 190 may alternatively or additional comprise an SMO and/or an RIC. In addition, any one or more of cell sites 111-113 may comprise 2G, 3G, 4G and/or LTE radios, e.g., in addition to 5G new radio (NR) functionality. For instance, in non-standalone (NSA) mode architecture, LTE radio equipment may continue to be used for cell signaling and management communications, while user data may rely upon a 5G new radio (NR), including millimeter wave communications, for example. Thus, these and other modifications are all contemplated within the scope of the present disclosure.

FIG. 4 illustrates a flowchart of an example method 400 for transmitting at least a first MDT RAN performance measurement request to a first plurality of endpoint devices in a cellular network with an instruction to skip transmission of a MDT RAN performance measurement report when the endpoint device is not able to include location information, in accordance with the present disclosure. In one example, steps, functions and/or operations of the method 400 may be performed by a device as illustrated in FIG. 1, e.g., a base station, an application server, a SON/SDN controller, or any one or more components thereof, such as a processing system, a processing system in conjunction with remote radio heads and/or antenna arrays, and so forth. Alternatively, or in addition, the steps, functions and/or operations of the method 400 may be performed by a processing system comprising a plurality of devices as illustrated in FIG. 1, such as an application server, a SON/SDN controller, a base station, a serving gateway, and so forth. In one example, the steps, functions, or operations of method 400 may be performed by a computing device or system 700, and/or a processing system 702 as described in connection with FIG. 7 below. For instance, the computing device 700 may represent at least a portion of an application server, a SON/SDN controller, a base station, a RAN intelligent controller, a NWDAF, and so forth, in accordance with the present disclosure. For illustrative purposes, the method 400 is described in greater detail below in connection with an example performed by a processing system, such as processing system 702. The method 400 begins in step 405 and may proceed to optional step 410 of to step 420.

At optional step 410, the processing system may determine that location information is desired for at least one minimization of drive tests (MDT) radio access network (RAN) performance measurement. For instance, in many cases, detailed location information (e.g., from GPS/GNSS units) is relevant to the collection of MDT RAN performance measurements. However, in some cases, detailed location information is not strictly required, e.g., merely the fact that an endpoint device may be connected to a particular cell site may be sufficient.

At step 420, the processing system (e.g., of a cellular network) may transmit at least a first minimization of drive tests (MDT) radio access network (RAN) performance measurement request to a first plurality of endpoint devices in a cellular network, wherein the at least the first MDT RAN performance measurement request includes a plurality of fields, the plurality of fields including: at least one instruction to collect at least one MDT RAN performance measurement, an instruction to include a location information associated with a collection of the at least one MDT RAN performance measurement, and an instruction to skip transmission of a MDT RAN performance measurement report in accordance with the at least the first MDT RAN performance measurement request when the endpoint device is not able to include the location information (e.g., when it is not possible for the endpoint device to include the location information associated with a collection of the at least one MDT RAN performance measurement (e.g., when the endpoint device is not GPS/GNSS equipped and/or cannot obtain a current measurement) or when the endpoint device is configured to block an inclusion of the location information in MDT RAN performance measurement reports).

For instance, the at least one instruction to collect the at least one MDT RAN performance measurement may include an instruction to the endpoint device to collect measurements of a particular type of performance indicator, to collect measurements with a particular periodicity, to report measurements with a particular periodicity, to report measurement records on demand, to report measurement records via a particular type of radio access technology (e.g., via LTE components of the cellular network), to report measurement records when a measurement of a performance indicator exceeds a fixed or relative threshold, and so on. The at least one MDT RAN performance measurement may be for a wireless signal quality, such as reference signal received power (RSRP), reference signal received quality (RSRQ), an intra-cell interference measurement, such as a signal-to-interference-and-noise (SINR) ratio with respect to a serving cell, or the like, and/or an inter-cell interference measurement, such as intra-frequency, inter-frequency, and/or inter-radio access technology measurements with respect to neighbor cells, and so forth. In one example, the instruction to skip transmission of the MDT RAN performance measurement report may be included in the at least the first MDT RAN performance measurement request when it is determined that the location information is desired at optional step 410. In one example, the at least the first MDT RAN performance measurement request may be sent via at least one RAN node (e.g., a cell site/base) station via a downlink control channel, e.g., via radio resource control signaling or the like. In one example, the at least the first MDT RAN performance measurement request may be the same as or similar to MDT RAN performance measurement request 200 of FIG. 2.

At optional step 430, the processing system may transmit at least one wireless signal, e.g., from a RAN node of the cellular network. For instance, in one example, the processing system may comprise a RAN node, e.g., a base station/cell site, a centralized unit (CU) and/or a distributed unit (DU), a baseband unit (BBU) and/or remote radio head (RRH), and so forth. In another example, the processing system may send instructions to a RAN node/base station to transmit the at least one wireless signal. The at least one wireless signal may comprise a signal (or a channel) related to initial access procedures, such as a primary synchronization signal (PSS), a secondary synchronization signal (SSS), a physical broadcast channel (PBCH), and/or a downlink modulation reference signal (DMRS)) contained within a synchronization signaling (SS) block). In one example, the at least one wireless signal may comprise a reference signal (RS), or multiple reference signals, as an alternative or in addition to the SS block, such as a channel station information reference signal CSI-RS. In one example, the at least one wireless signal may be transmitted via a directional antenna, e.g., a phased array antenna for beamforming. Thus, the at least one wireless signal may be associated with a particular transmit beam or transmit beam direction (in azimuth and elevation) with respect to the phased antenna array. In one example, the at least one wireless signal may comprise a plurality of wireless signals, such as successive synchronization signals or reference signals over multiple bursts via the same or different transmit beams, and so forth.

At step 440, the processing system obtains, via the cellular network, at least a first MDT RAN performance measurement report from at least a first endpoint device of the first plurality of endpoint devices that is capable of including the location information associated with the collection of the at least one MDT RAN performance measurement and that is configured to allow an inclusion of the location information in MDT RAN performance measurement reports. In one example, the at least the first MDT RAN performance measurement report may include the at least one MDT RAN performance measurement that is requested at step 420, where the at least one MDT RAN performance measurement may be gathered by the at least the first endpoint device based upon at least one wireless signal from a base station of the cellular network (e.g., as described above in connection with optional step 430). In one example, the at least the first MDT RAN performance measurement report may be received via radio resource control signaling, for instance. In one example, the receiving may be via a different base station or cell site than the base station or cell site from which the at least one wireless signal is transmitted. The at least one MDT RAN performance measurement may comprise a received signal strength, a bit error rate, a packet loss rate, a round trip time, a delay measure, a beam failure event, a radio link interruption event, a random access procedure failure event, or the like. In one example, the MDT RAN performance measurement may be collected by the endpoint device based upon a pre-configuration or based upon a configuration instruction received by the endpoint device and sent by the processing system at step 420.

At step 450, the processing system stores the at least the first MDT RAN performance measurement report that is obtained. For instance, the at least the first MDT RAN performance measurement report may be stored in a database system that is a component of the processing system or that is accessible to the processing system over one or more networks (e.g., one or more co-located or distributed database server(s)). For example, the processing system may comprise a trace collection entity (TCE), a network data analytics functions (NWDAF), or the like.

At optional step 460, the processing system may adjust at least one aspect of the cellular network in response to the at least the first MDT RAN performance measurement report. For example, the adjusting the at least one aspect of the cellular network may include: activating a remote radio head, activating a baseband unit, deactivating a remote radio head, deactivating a baseband unit, changing a transmit power of a base station, changing a boresight direction of an antenna array (including adjusting tilt and azimuth bearing), changing a beamwidth of a gain pattern of an antenna array, changing a channel coding scheme availability at a base station, changing a base station backhaul configuration, and so forth.

For instance, the processing system may determine that endpoint devices in a given location may be subject to a relatively greater number of link failure events with respect to a cell site in a given direction/orientation from the area. For example, the location may be a sidewalk across the street from a cell site, where there is a large amount of truck traffic which may temporarily block line-of-sight communications. In such case, the processing system may adjust a boresight of an antenna array of the base station e.g., using electro-mechanical elevation or azimuth tilt which may provide a relatively greater number of directional beams in other directions which may reach the mobile endpoint devices in the area via multiple alternative paths, e.g., reflections off of nearby buildings, and the like. In another example, there may be a remote radio head available on the same side of the street that may not be subject to the same path blocking as signals from the other base station. Therefore, optional step 460 may comprise activating a remote radio head to better serve the location. It should be noted that optional step 460 may comprise any number of different types of remedial actions to configure or reconfigure the cellular network in response to the measurement of the performance indicator, the location, and/or other information contained in the at least the first MDT RAN performance measurement report.

At optional step 470, the processing system may determine that an expected MDT RAN performance measurement report is not received from at least a second endpoint device of the plurality of endpoint devices or that for at least one endpoint device, at least one MDT RAN performance measurement report omits a location information of the at least one endpoint device.

At optional step 480, the processing system may add the at least the second endpoint device or the at least one endpoint device to a set of non-participating endpoint devices that do not participate in MDT RAN performance measurement reporting.

At optional step 490, the processing system may transmit at least a second MDT RAN performance measurement request to a second plurality of endpoint devices in the cellular network, where a selection of the second plurality of endpoint devices is based upon the set of non-participating endpoint devices.

For instance, endpoint devices in the set of non-participating endpoint devices may be excluded from some or all subsequent MDT RAN performance measurement requests. However, it should be noted that there are some metrics for which specific location information is not strictly required. For example, a cellular network may be interested in some metric for endpoint devices attached to particular cell sites, but the precise geographic location may be not of interest, only the fact that an endpoint device is attached to that specific cell site. In such case, even endpoint devices that are not capable of or decline to include location information may still be targeted with MDT RAN measurement requests and may provide MDT RAN measurement reports, e.g., with the location information excluded. However, for the vast majority of MDT RAN measurement request for which location information is relevant, the volume of wasted reports without location information may be drastically reduced.

Following step 450 or any of optional steps 460-490, the method 400 proceeds to step 495 where the method 400 ends.

It should be noted that the method 400 may be expanded to include additional steps or may be modified to include additional operations with respect to the steps outlined above. For example, the method 400 may be repeated through various cycles of MDT RAN performance indicator measurements, various cycles of adjustments to a cellular network, and so forth. For instance, endpoint devices may continue to move throughout an environment, capture measurements of MDT RAN performance indicators, locations, etc., and report back to the cellular network. In addition, endpoint devices may be added to the set of non-participating endpoint devices. In one example, endpoint devices in the set of non-participating endpoint devices may still be periodically included in MDT RAN performance measurement requests, e.g., to potentially obtain one or more MDT measurement reports from such endpoint devices to see if any setting has changed or if a capability to provide location information has changed. As such, endpoint devices may also be taken out of the set/list of non-participating endpoint devices.

In one example, the method 400 may be expanded to alternatively or additionally include an additional field/information element in the at least the first MDT RAN performance measurement request that indicates to skip sending an MDT RAN performance measurement report when a receiving endpoint device is not to include spatial orientation information. For instance, an endpoint device may be incapable of determining spatial orientation information, or may be so equipped, but may be configured to not share spatial orientation information. In such case, endpoint devices may respond accordingly and may decline to send MDT RAN performance measurement reports. Alternatively, or in addition, the cellular network (e.g., the processing system or other network component) may receive an MDT RAN performance measurement report with expected spatial orientation information missing. In either case, the endpoint device may be added to the same or a different list of non-participating endpoint devices (e.g., those that are known to not provide spatial orientation information). In one example, the method 400 may be expanded or modified to include steps, functions, and/or operations, or other features described in connection with the example(s) of FIGS. 1-3, FIG. 5, and/or FIG. 6, or as described elsewhere herein. Thus, these and other modifications are all contemplated within the scope of the present disclosure.

FIG. 5 illustrates a flowchart of an example method 500 for transmitting at least a first MDT RAN performance measurement request to a first plurality of endpoint devices identified in accordance with a set of non-participating endpoint devices that do not participate in MDT RAN performance measurement reporting, in accordance with the present disclosure. In one example, steps, functions and/or operations of the method 500 may be performed by a device as illustrated in FIG. 1, e.g., a base station, an application server, a SON/SDN controller, or any one or more components thereof, such as a processing system, a processing system in conjunction with remote radio heads and/or antenna arrays, and so forth. Alternatively, or in addition, the steps, functions and/or operations of the method 500 may be performed by a processing system comprising a plurality of devices as illustrated in FIG. 1, such as an application server, a SON/SDN controller, a base station, a serving gateway, and so forth. In one example, the steps, functions, or operations of method 500 may be performed by a computing device or system 700, and/or a processing system 702 as described in connection with FIG. 7 below. For instance, the computing device 700 may represent at least a portion of an application server, a SON/SDN controller, a base station, a RAN intelligent controller, a NWDAF, and so forth, in accordance with the present disclosure. For illustrative purposes, the method 500 is described in greater detail below in connection with an example performed by a processing system, such as processing system 702. The method 500 begins in step 505 and proceeds to step 510.

At step 510, the processing system identifies at least one MDT RAN performance measurement to be collected in an area (e.g., the area include one or more RAN nodes/cell sites). For instance, the at least one MDT RAN performance measurement may include a wireless signal quality, such as reference signal received power (RSRP), reference signal received quality (RSRQ), an intra-cell interference measurement, such as a signal-to-interference-and-noise (SINR) ratio with respect to a serving cell, or the like, and/or an inter-cell interference measurement, such as intra-frequency, inter-frequency, and/or inter-radio access technology measurements with respect to neighbor cells, and so forth.

At step 520, the processing system identifies a first plurality of endpoint devices available in the area to collect the at least one MDT RAN performance measurement. In particular, step 520 may include a reference to a set of non-participating endpoint devices that do not participate in MDT RAN performance measurement reporting. For instance, endpoint devices in such a set, e.g., a list, may be excluded from consideration for the first plurality of endpoint devices. On the other hand, endpoint devices that are not in the set of non-participating devices and that may be in the area for which MDT RAN performance measurements are to be collected may be included in the first plurality of endpoint devices.

At step 530, the processing system transmits at least a first MDT RAN performance measurement request to the first plurality of endpoint devices. In the present example, the MDT RAN performance measurement request may include a plurality of fields, the plurality of fields including: at least one instruction to collect the at least one MDT RAN performance measurement and an instruction to include a location information associated with a collection of the at least one MDT RAN performance measurement. In one example, the MDT RAN performance measurement request may further include an instruction to skip transmission of a MDT RAN performance measurement report in accordance with the at least the first MDT RAN performance measurement request when a receiving endpoint device is not able to include the location information (e.g., when it is not possible for the endpoint device to include the location information associated with a collection of the at least one MDT RAN performance measurement (e.g., when the endpoint device is not GPS/GNSS equipped and/or cannot obtain a current measurement) or when the endpoint device is configured to block an inclusion of the location information in MDT RAN performance measurement reports). In one example, the at least the first MDT RAN performance measurement request may be sent via at least one cell site/base station via a downlink control channel, e.g., via radio resource control signaling or the like. In one example, step 530 may comprise the same or similar operations as step 420 of the example method 400 of FIG. 4, as discussed above.

At optional step 540, the processing system may transmit at least one wireless signal, e.g., from a base station of the cellular network. For instance, in one example, the processing system may comprise a radio access network node, e.g., a base station, a centralized unit (CU) and/or a distributed unit (DU), a baseband unit (BBU) and/or remote radio head (RRH), and so forth. In another example, the processing system may send instructions to a radio access network node/base station to transmit the at least one wireless signal. The at least one wireless signal may comprise a signal (or a channel) related to initial access procedures, such as a primary synchronization signal (PSS), a secondary synchronization signal (SSS), a physical broadcast channel (PBCH), and/or a downlink modulation reference signal (DMRS)) contained within a synchronization signaling (SS) block). In one example, the at least one wireless signal may comprise a reference signal (RS), or multiple reference signals, as an alternative or in addition to the SS block, such as a channel station information reference signal CSI-RS. In one example, the at least one wireless signal is transmitted via a directional antenna, e.g., a phased array antenna for beamforming. Thus, the at least one wireless signal may be associated with a particular transmit beam or transmit beam direction (in azimuth and elevation) with respect to the phased antenna array. In one example, the at least one wireless signal may comprise a plurality of wireless signals, such as successive synchronization signals or reference signals over multiple bursts via the same or different transmit beams, and so forth. In one example, optional step 540 may comprise the same or similar operations as optional step 430 of the example method 400 of FIG. 4, as discussed above.

At step 550, the processing system obtains, via the cellular network, at least a first MDT RAN performance measurement report from at least a first endpoint device of the first plurality of endpoint devices. In one example, the at least the first MDT RAN performance measurement report may include the at least one MDT RAN performance measurement that is requested at step 530, where the at least one MDT RAN performance measurement may be gathered by the at least the first endpoint device based upon at least one wireless signal from a RAN node/base station of the cellular network (e.g., as described above in connection with optional step 540). In one example, the at least the first MDT RAN performance measurement report may be received via radio resource control signaling, for instance. In one example, the receiving may be via a different base station or cell site than the base station or cell site from which the at least one wireless signal is transmitted. The at least one MDT RAN performance measurement may comprise a received signal strength, a bit error rate, a packet loss rate, a round trip time, a delay measure, a beam failure event, a radio link interruption event, a random access procedure failure event, or the like. In one example, the MDT RAN performance measurement may be collected by an endpoint device based upon a pre-configuration or based upon a configuration instruction received by the mobile endpoint device and sent by the processing system at step 530.

In one example, the at least the first endpoint device may be capable of including the location information associated with the collection of the at least one MDT RAN performance measurement and may be configured to allow an inclusion of the location information in MDT RAN performance measurement reports. In such case, the at least the first MDT RAN performance measurement report may include the at least one MDT RAN performance measurement along with location information (e.g., GPS/GNSS determined location information). In one example, the at least one MDT RAN performance measurement report may include additional information, such as spatial orientation information, and so forth. However, in another example, the at least the first MDT RAN performance measurement report may include, for at least one endpoint device, at least one MDT RAN performance measurement report that omits a location information of the at least one endpoint device.

At step 560, the processing system stores the at least the first MDT RAN performance measurement report that is obtained. For instance, the at least the first MDT RAN performance measurement report may be stored in a database system that is a component of the processing system or that is accessible to the processing system over one or more networks (e.g., one or more co-located or distributed database server(s)). For example, the processing system may comprise a trace collection entity (TCE), a network data analytics functions (NWDAF), or the like. In one example, step 560 may comprise the same or similar operations as step 450 of the example method 400 of FIG. 4, as discussed above.

At optional step 570, the processing system may adjust at least one aspect of the cellular network in response to the at least the first MDT RAN performance measurement report. For example, the adjusting the at least one aspect of the cellular network may include: activating a remote radio head, activating a baseband unit, deactivating a remote radio head, deactivating a baseband unit, changing a transmit power of a base station, changing a boresight direction of an antenna array (including adjusting tilt and azimuth bearing), changing a beamwidth of a gain pattern of an antenna array, changing a channel coding scheme availability at a base station, changing a base station backhaul configuration, and so forth. In one example, optional step 570 may comprise the same or similar operations as optional step 560 of the example method 400 of FIG. 4, as discussed above.

At optional step 580, the processing system may determine that an expected MDT RAN performance measurement report is not received from at least a second endpoint device of the plurality of endpoint devices or that for at least one endpoint device, at least one MDT RAN performance measurement report omits a location information of the at least one endpoint device.

At optional step 590, the processing system may add the at least the second endpoint device or the at least one endpoint device to the list of non-participating endpoint devices that do not participate in MDT RAN performance measurement reporting.

Following step 550 or any of optional steps 560-590, the method 500 proceeds to step 595 where the method 500 ends.

It should be noted that the method 500 may be expanded to include additional steps or may be modified to include additional operations with respect to the steps outlined above. For example, the method 500 may be repeated through various cycles of MDT RAN performance indicator measurements, various cycles of adjustments to a cellular network, and so forth. For instance, endpoint devices may continue to move throughout an environment, capture measurements of MDT RAN performance indicators, locations, etc., and report back to the cellular network. In addition, endpoint devices may be added to the set of non-participating endpoint devices. Thus, for example, the processing system may transmit at least a second MDT RAN performance measurement request to a second plurality of endpoint devices in the cellular network, where a selection of the second plurality of endpoint devices is based upon the set of non-participating endpoint devices (e.g., that may be updated at optional step 590). In one example, endpoint devices in the set of non-participating endpoint devices may still be periodically included in MDT RAN performance measurement requests, e.g., to potentially obtain one or more MDT measurement reports from such endpoint devices to see if any setting or capability to provide location information has changed. As such, endpoint devices may also be taken out of the set/list of non-participating endpoint devices.

In one example, the method 500 may be expanded to alternatively or additionally include an additional field/information element in the at least the first MDT RAN performance measurement request that indicates to skip sending an MDT RAN performance measurement report when a receiving endpoint device is not to include spatial orientation information. For instance, an endpoint device may be incapable of determining spatial orientation information, or may be so equipped, but may be configured to not share spatial orientation information. In such case, endpoint devices may respond accordingly and may decline to send MDT RAN performance measurement reports. Alternatively, or in addition, the cellular network (e.g., the processing system or other network component) may receive an MDT RAN performance measurement report with expected spatial orientation information missing. In either case, the endpoint device may be added to the same or a different list of non-participating endpoint devices (e.g., those that are known to not provide spatial orientation information). In one example, the method 500 may be expanded or modified to include steps, functions, and/or operations, or other features described in connection with the example(s) of FIGS. 1-4 and/or FIG. 6, or as described elsewhere herein. Thus, these and other modifications are all contemplated within the scope of the present disclosure.

FIG. 6 illustrates a flowchart of an example method 600 for an endpoint device suppressing a transmission of a MDT RAN performance measurement report in accordance with an instruction to skip the transmission when the endpoint device is to not include location information in the MDT RAN performance measurement report, in accordance with the present disclosure. In one example, steps, functions and/or operations of the method 600 may be performed by an endpoint device as illustrated in FIG. 1, e.g., a mobile endpoint device and/or a UE, a customer premises equipment (CPE), or any one or more components thereof, such as a processing system, a GPS/GNSS unit, a phased antenna array, and so forth. In one example, the steps, functions, or operations of method 600 may be performed by a computing device or system 700, and/or a processing system 702 as described in connection with FIG. 7 below. For instance, the computing device 700 may represent at least a portion of a mobile endpoint device, UE, and/or CPE in accordance with the present disclosure. For illustrative purposes, the method 600 is described in greater detail below in connection with an example performed by a processing system, such as processing system 702. The method 600 begins in step 605 and proceeds to step 610.

At step 610, the processing system (e.g., of an endpoint device) receives a MDT RAN performance measurement request, where the MDT RAN performance measurement request includes a plurality of fields, the plurality of fields including: at least one instruction to collect at least one MDT RAN performance measurement, an instruction to include a location information associated with a collection of the at least one MDT RAN performance measurement, and an instruction to skip a transmission of a MDT RAN performance measurement report in accordance with the at least the first MDT RAN performance measurement request when the endpoint device is not to include the location information. In one example, the MDT RAN performance measurement request may be the same or similar to MDT RAN performance measurement request 200 of FIG. 2.

At step 620, the processing system determines that the endpoint device is not to include the location information. For example, step 620 may comprise determining that it is not possible for the endpoint device to include the location information associated with a collection of the at least one MDT RAN performance measurement (e.g., when the endpoint device is not GPS/GNSS equipped and/or cannot currently track reference satellites) or determining that the endpoint device is configured to block an inclusion of the location information in MDT RAN performance measurement reports.

At step 630, the processing system suppresses a transmission of the MDT RAN performance measurement report in accordance with the instruction to skip the transmission and in response to determining that the endpoint device is to not include the location information. For instance, the processing system may specifically select to not collect MDT RAN performance measurement(s) and/or to not send a MDT RAN performance measurement report to a RAN node/cell site to which the endpoint device is attached or to which the endpoint device could attach. Following step 630, the method 600 proceeds to step 695 where the method ends.

It should be noted that the method 600 may be expanded to include additional steps or may be modified to include additional operations with respect to the steps outlined above. For example, the method 600 may be repeated through various cycles of receiving MDT RAN performance indicator measurement requests. For instance, the endpoint device may continue to move throughout an environment and may have its settings changed to permit location information sharing, may re-acquire reference satellite signals for detailed GPS/GNSS location determination (e.g., where the endpoint device may previously have been temporarily unable to do so, and so forth). It should be noted that in another example, the method 600 may instead comprise subsequently determining, by the endpoint device, that the endpoint device is now able to include the location information, and transmitting, by the endpoint device to the cellular network, the MDT RAN performance measurement report including the location information. Alternatively, or in addition, the processing system may determine at another time, in another location, etc. that the endpoint device is to include location information. For instance, a setting may have been changed, e.g., by a user, to allow location sharing and/or the endpoint device may instead be in location in which GPS/GNSS location is determinable.

In one example, the method 600 may be expanded to alternatively or additionally include receiving an MDT RAN performance measurement request with an additional field/information element that indicates to skip sending an MDT RAN performance measurement report when a receiving endpoint device is not to include spatial orientation information. In such case, the processing system may determine whether the endpoint device is capable of determining spatial orientation information (e.g., using a gyroscope and compass, or the like) and/or whether the endpoint device is configured to block sharing of such information, and may transmit or suppress an MDT RAN performance measurement report accordingly. In one example, the method 600 may be expanded or modified to include steps, functions, and/or operations, or other features described in connection with the example(s) of FIGS. 1-5, or as described elsewhere herein. Thus, these and other modifications are all contemplated within the scope of the present disclosure.

In addition, although not specifically specified, one or more steps, functions, or operations of the respective methods 400, 500, and 600 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIGS. 4-6 that recite a determining operation or involve a decision do not necessarily require that both branches of the determining operation be practiced. In other words, one of the branches of the determining operation can be deemed as an optional step.

Furthermore, steps, blocks, functions or operations of the above described method(s) can be combined, separated, and/or performed in a different order from that described above, without departing from the example examples of the present disclosure.

FIG. 7 depicts a high-level block diagram of a computing device or processing system specifically programmed to perform the functions described herein. As depicted in FIG. 7, the processing system 700 comprises one or more hardware processor elements 702 (e.g., a central processing unit (CPU), a microprocessor, or a multi-core processor), a memory 704 (e.g., random access memory (RAM) and/or read only memory (ROM)), a module 705 for transmitting at least a first MDT RAN performance measurement request to a first plurality of endpoint devices in a cellular network with an instruction to skip transmission of a MDT RAN performance measurement report when the endpoint device is not to include location information, for transmitting at least a first MDT RAN performance measurement request to a first plurality of endpoint devices identified in accordance with a set of non-participating endpoint devices that do not participate in MDT RAN performance measurement reporting, and/or for an endpoint device suppressing a transmission of a MDT RAN performance measurement report in accordance with an instruction to skip the transmission when the endpoint device is to not include location information in the MDT RAN performance measurement report, and various input/output devices 706 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 706 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if any one or more of the methods 400-600 as discussed above are implemented in a distributed or parallel manner for a particular illustrative example, i.e., the steps of the above methods 400-600, respectively, or each of the entire methods 400 600, respectively, is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 702 can also be configured or programmed to cause other devices to perform one or more operations as discussed above. In other words, the hardware processor 702 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods. In one example, instructions and data for the present module or process 705 for transmitting at least a first MDT RAN performance measurement request to a first plurality of endpoint devices in a cellular network with an instruction to skip transmission of a MDT RAN performance measurement report when the endpoint device is not to include location information, for transmitting at least a first MDT RAN performance measurement request to a first plurality of endpoint devices identified in accordance with a set of non-participating endpoint devices that do not participate in MDT RAN performance measurement reporting, and/or for an endpoint device suppressing a transmission of a MDT RAN performance measurement report in accordance with an instruction to skip the transmission when the endpoint device is to not include location information in the MDT RAN performance measurement report (e.g., a software program comprising computer-executable instructions) can be loaded into memory 704 and executed by hardware processor element 702 to implement the steps, functions, or operations as discussed above in connection with the illustrative methods. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 705 for transmitting at least a first MDT RAN performance measurement request to a first plurality of endpoint devices in a cellular network with an instruction to skip transmission of a MDT RAN performance measurement report when the endpoint device is not to include location information, for transmitting at least a first MDT RAN performance measurement request to a first plurality of endpoint devices identified in accordance with a set of non-participating endpoint devices that do not participate in MDT RAN performance measurement reporting, and/or for an endpoint device suppressing a transmission of a MDT RAN performance measurement report in accordance with an instruction to skip the transmission when the endpoint device is to not include location information in the MDT RAN performance measurement report (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
transmitting, by a processing system including at least one processor, at least a first minimization of drive tests radio access network performance measurement request to a first plurality of endpoint devices in a cellular network, wherein the at least the first minimization of drive tests radio access network performance measurement request includes a plurality of fields, wherein the plurality of fields includes:
at least one instruction to collect at least one minimization of drive tests radio access network performance measurement;
an instruction to include a location information associated with a collection of the at least one minimization of drive tests radio access network performance measurement; and
an instruction to skip a transmission of a minimization of drive tests radio access network performance measurement report in accordance with the at least the first minimization of drive tests radio access network performance measurement request when a recipient endpoint device is not to include the location information;
obtaining, by the processing system via the cellular network, at least a first minimization of drive tests radio access network performance measurement report from at least a first endpoint device of the first plurality of endpoint devices that is capable of including the location information associated with the collection of the at least one minimization of drive tests radio access network performance measurement; and
storing, by the processing system, the at least the first minimization of drive tests radio access network performance measurement report that is obtained.

2. The method of claim 1, further comprising:
determining that an expected minimization of drive tests radio access network performance measurement report is not received from at least a second endpoint device of the first plurality of endpoint devices.

3. The method of claim 2, further comprising:
adding the at least the second endpoint device to a set of non-participating endpoint devices that do not participate in minimization of drive tests radio access network performance measurement reporting.

4. The method of claim 3, further comprising:
transmitting at least a second minimization of drive tests radio access network performance measurement request to a second plurality of endpoint devices in the cellular network, wherein a selection of the second plurality of endpoint devices is based upon the set of non-participating endpoint devices.

5. The method of claim 1, further comprising:
determining that the location information is desired for the at least one minimization of drive tests radio access network performance measurement, wherein the instruction to skip the transmission of the minimization of drive tests radio access network performance measurement report is included in the at least the first minimization of drive tests radio access network performance measurement request when it is determined that the location information is desired.

6. The method of claim 1, wherein the processing system comprises:
a trace collection entity deployed in the cellular network.

7. The method of claim 1, wherein the processing system comprises:
a radio access network node.

8. The method of claim 1, wherein the at least one radio access network performance measurement comprises at least one of:
a reference signal received power;
a reference signal received quality;
an intra-cell interference measurement; or
an inter-cell interference measurement.

9. A method comprising:
identifying, by a processing system including at least one processor, at least one minimization of drive tests radio access network performance measurement to be collected in an area;
identifying, by the processing system, a first plurality of endpoint devices available in the area to collect the at least one minimization of drive tests radio access network performance measurement, wherein the identifying of the first plurality of endpoint devices includes a reference to a set of non-participating endpoint devices that do not participate in minimization of drive tests radio access network performance measurement reporting;
transmitting, by the processing system, at least a first minimization of drive tests radio access network performance measurement request to the first plurality of endpoint devices, wherein the at least the first minimization of drive tests radio access network performance measurement request includes a plurality of fields, wherein the plurality of fields includes:
at least one instruction to collect the at least one minimization of drive tests radio access network performance measurement; and
an instruction to include a location information associated with a collection of the at least one minimization of drive tests radio access network performance measurement;
obtaining, by the processing system via the cellular network, at least a first minimization of drive tests radio access network performance measurement report from at least a first endpoint device of the first plurality of endpoint devices; and
storing, by the processing system, the at least the first minimization of drive tests radio access network performance measurement report that is obtained.

10. The method of claim 9, wherein the plurality of fields further includes:
an instruction to skip a transmission of a minimization of drive tests radio access network performance measurement report in accordance with the at least the first minimization of drive tests radio access network performance measurement request when a recipient endpoint device is not to include the location information.

11. The method of claim 10, wherein the at least the first endpoint device is capable of including the location information associated with the collection of the at least one minimization of drive tests radio access network performance measurement and is configured to allow an inclusion of the location information in minimization of drive tests radio access network performance measurement reports.

12. The method of claim 10, further comprising:
determining that an expected minimization of drive tests radio access network performance measurement report is not received from at least a second endpoint device of the first plurality of endpoint devices.

13. The method of claim 12, further comprising:
adding the at least the second endpoint device to the set of non-participating endpoint devices.

14. The method of claim 9, wherein the at least the first minimization of drive tests radio access network performance measurement report comprises, for at least one endpoint device, at least one minimization of drive tests radio access network performance measurement report that omits a location information of the at least one endpoint device.

15. The method of claim 14, further comprising:
adding the at least one endpoint device to the set of non-participating endpoint devices.

16. The method of claim 9, wherein the processing system comprises:
a trace collection entity deployed in the cellular network.

17. The method of claim 9, wherein the processing system comprises:
a radio access network node.

18. The method of claim 9, wherein the at least one radio access network performance measurement comprises at least one of:
a reference signal received power;
a reference signal received quality;
an intra-cell interference measurement; or
an inter-cell interference measurement.

19. A method comprising:
receiving, by a processing system of an endpoint device, a minimization of drive tests radio access network performance measurement request, wherein the minimization of drive tests radio access network performance measurement request includes a plurality of fields, wherein the plurality of fields includes:
at least one instruction to collect at least one minimization of drive tests radio access network performance measurement;
an instruction to include a location information associated with a collection of the at least one minimization of drive tests radio access network performance measurement; and
an instruction to skip transmission of a minimization of drive tests radio access network performance measurement report in accordance with the at least the first minimization of drive tests radio access network performance measurement request when the endpoint device is not to include the location information;
determining, by the processing system, that the endpoint device is not to include the location information; and
suppressing, by the processing system, a collection or a transmission of the minimization of drive tests radio access network performance measurement report in accordance with the instruction to skip the transmission and in response to determining that the endpoint device is to not include the location information.

20. The method of claim 19, wherein the determining that the endpoint device is to not include the location information comprises determining:
that it is not possible for the endpoint device to collect the location information; or
that the endpoint device is configured to block an inclusion of the location information in minimization of drive tests radio access network performance measurement reports.
